(19) United States
(12) Patent Application Publication
(10) Pub. No.: US 2010/0026463 A1
(43) Pub. Date: Feb. 4, 2010

(54) READING APPARATUS AND CALLING APPARATUS AND ID READING PROGRAM AND ID READING METHOD

(75) Inventors: Hiroshi Ootaki, Tokyo (JP); Toshihisa Kamemaru, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: MITSUBISHI ELECTRIC CORPORATION, Chiyoda-ku ,Tokyo (JP)

(21) Appl. No.: 12/519,918

(22) PCT Filed: Dec. 28, 2006
(86) PCT No.: PCT/JP2006/326276

§ 371 Date: Jun. 18, 2009

(51) Int. Cl. H04Q 5/22

(52) U.S. Cl. 340/10.1

(57) ABSTRACT

The present invention is directed to locate easily an unread IC tag (a commodity attaching the IC tag), upon failing to read the IC tag. An invoice storing unit 14 of the gate type RFID apparatus 10 stores a tag ID of the IC tag to be read by the gate side reader/writer apparatus 11. The gate side reader/writer apparatus 11 reads a tag ID from each IC tag attached to a plurality of commodities. A read data storing unit 12 stores the tag ID read by the gate side reader/writer apparatus 11. A comparator 13 specifies a tag ID which has failed to be read by the gate side reader/writer apparatus 11, based on the tag ID stored on the invoice storing unit 14 and the tag ID stored on the read data storing unit 12. The comparator 13 transmits the specified tag ID to the handy type RFID apparatus 20. The handy type RFID apparatus 20, based on this tag ID, searches the IC tag which has failed to be read by the gate side reader/writer apparatus 11, based on this tag ID.

### TECHNICAL FIELD

The present invention relates to a reading apparatus, an ID reading program and an ID reading method, for reading information stored on the IC (integrated circuit) tag.

### BACKGROUND ART

Recently, a non-contact identification technology using radio waves known as RFID (Radio Frequency IDentification) has been utilized in various fields. Especially, an installation of the RFID is in progress in a field related to logistics. In the field related to logistics, upon receipts and shipments of commodities, until today, the commodities have been checked for their numbers and types by workers. However, the commodities are now checked all at once by adopting a commodity checking system represented by a gate type RFID so that a time taken in commodity checking operation has improved significantly.

However, a commodity search using the conventional RFID operates on the assumption that IC tag information including serial number, manufacturer number and model name of the commodity is read. When the information on the IC tag could not have been read, in status quo, the commodity search has to be relied on the worker.

For this reason, when the information on the IC tag is unread because of the way in which the commodities are being piled up or due to the surrounding situation, a commodity attaching the unreadable IC tag must be searched from an entire stock of the commodity, and there was a problem of taking too much time in locating such a commodity.

Japanese Patent Laid-open Publication No. 2005-179059 (a patent document 1) proposes a system for facilitating the commodity search within a storage facility utilizing the RFID. The patent document 1 discusses an IC tag searching method for facilitating the commodity search by acquiring from a database an external appearance data that corresponds to a commodity identifier read from the IC tag, and presenting the external appearance data to a displaying device mounted on a mobile terminal. However, when the information on the IC tag is unread, this technology provides no means for acquiring the external appearance data of the commodity having attached the unread IC tag, or finding the unread IC tag by presenting the external appearance data of the commodity having attached the unread IC tag on the displaying device of the mobile terminal or the like.

Japanese Patent Laid-open Publication No. 2002-338013 (a patent document 2) proposes a system for facilitating the commodity search or management by using a commodity management label and a commodity management controller. The patent document 2 discusses a tag searching method for attaching to a RFID tag itself the commodity management label carrying a function such as sound output or light output, performing requests such as sound output or light output from the commodity controller to the commodity management label, and facilitating the commodity search by outputting sound or light from the IC tag itself. However, this technology provides no means for easily locating those IC tags beyond the reach of the sound output and light output requests.

Japanese Patent Laid-open Publication No. 2005-237869 (a patent document 3) proposes a commodity information displaying system utilizing the reader/writer and the IC tag. The patent document 3 discusses a system that can acquire information contents without bypassing the network, by storing the information contents already acquired through the network in the past, such as a producer name and commodity information, on the memory inside the IC tag. This technology is a method of saving time spent in acquiring information and communication expense to the network, and it provides no means for easily locating the unread IC tag.

Patent document 1: Japanese Patent Laid-open Publication No. 2005-179059
Patent document 2: Japanese Patent Laid-open Publication No. 2002-338013
Patent document 3: Japanese Patent Laid-open Publication No. 2005-237869

### DISCLOSURE OF THE INVENTION

### Problems to be Solved by the Invention

As described above, the methods discussed in Japanese Patent Laid-open Publication No. 2005-179059 (the patent document 1), Japanese Patent Laid-open Publication No. 2002-338013 (the patent document 2), and Japanese Patent Laid-open Publication No. 2005-237869 (the patent document 3) are based on the assumption that the IC tag information including serial number, manufacturer number and model name of the commodity is readable, and they do not provide means for easily locating the unread IC tag when reading fails. For this reason, the IC tag which is unread must be searched by the worker from the entire stock of commodity upon an occurrence of the unread IC tag, and there was a problem of taking too much time until locating such an IC tag.

The present invention aims to provide a searching method for easily locating the unread IC tag when the occurrence of the unread IC tag.

### Means to Solve the Problems

A reading apparatus, comprising:

a reader unit that reads an apparatus ID from a communication apparatus by using a radio communication, by calling, based on a wireless signal, the communication apparatus having attached its own apparatus ID (identification) and performing the radio communication by receiving a call of the wireless signal, wherein the communication apparatus is attached to a commodity;

a first storing unit that stores a read ID which is the apparatus ID read by the reader unit;

a second storing unit that stores in advance a prepared ID which is the apparatus ID to be read by the reader unit; and

a specifying unit that specifies an apparatus ID failed to be read by the reader unit as an unread ID, by comparing the read ID stored by the first storing unit and the prepared ID stored by the second storing unit.

The reading apparatus including the specifying unit that transmits the specified unread ID to an other apparatus.

The reading apparatus including the specifying unit that transmits the unread ID to a calling apparatus, as the other apparatus, that can perform the radio communication, by calling the communication apparatus based on the apparatus ID.

The reading apparatus including the specifying unit that specifies the visual information corresponding to the unread ID by communicating to a database storing unit that stores, by associating the visual information which is an information related to an external appearance of the commodity attaching the communication apparatus with the apparatus ID of the communication apparatus.

The reading apparatus including the specifying unit that transmits the unread ID specified and the visual information corresponding to the unread ID, to the other apparatus.

The reading apparatus including the second storing unit that acquires the prepared ID from the database storing unit that stores the prepared ID, and that stores the prepared ID acquired.

The reading apparatus further comprises a data writing unit for writing the unread ID specified by the specifying unit to a storage medium which is capable of writing data.

A calling apparatus, comprising:

a receiving unit that receives an unread ID from a specifying unit of a reading apparatus which includes: a reader unit that reads an apparatus ID from a communication apparatus by using a radio communication, by calling, based on a wireless signal, the communication apparatus having attached its own apparatus ID (identification) and performing the radio communication by receiving a call of the wireless signal, wherein the communication apparatus is attached to a commodity; a first storing unit that stores a read ID which is the apparatus ID read by the reader unit; a second storing unit that stores in advance a prepared ID which is the apparatus ID to be read by the reader unit; and a specifying unit that specifies an apparatus ID failed to be read by the reader unit as an unread ID, by comparing the read ID stored by the first storing unit and the prepared ID stored by the second storing unit, and that transmits the specified unread ID to the other apparatus;

a calling unit that transmits a call signal for calling the communication apparatus having the unread ID based on the unread ID received by the receiving unit, and that receives from the communication apparatus being called a response signal for responding to the call signal; and

a displaying unit that displays a reception display indicating reception of the response signal by the calling unit when the call signal is received by the calling unit.

A calling apparatus, comprising:

a receiving unit that receives an unread ID from a specifying unit of a reading apparatus which includes: a reader unit that reads an apparatus ID from a communication apparatus by using a radio communication, by calling, based on a wireless signal, the communication apparatus having attached its own apparatus ID (identification) and performing the radio communication by receiving a call of the wireless signal, wherein the communication apparatus is attached to a commodity; a first storing unit that stores a read ID which is the apparatus ID read by the reader unit; a second storing unit that stores in advance a prepared ID which is the apparatus ID to be read by the reader unit; and a specifying unit that specifies an apparatus ID failed to be read by the reader unit as an unread ID, by comparing the read ID stored by the first storing unit and the prepared ID stored by the second storing unit, that specifies the visual information corresponding to the unread ID by communicating to a database storing unit that stores, by associating the visual information which is an information related to an external appearance of the commodity attaching the communication apparatus with the apparatus ID of the communication apparatus, and that transmits the specified unread ID and the visual information to the other apparatus;

a calling unit that transmits a call signal for calling the communication apparatus having the unread ID based on the unread ID received by the receiving unit, and that receives from the communication apparatus being called a response signal for responding to the call signal; and

a displaying unit that displays a visual information corresponding to the unread ID which is used for calling by the calling unit when the call signal is received by the calling unit.

An ID (Identification) reading program which is characterized in that the following processes executed by a computer is serving as the reading apparatus;

(1) a process of reading an apparatus ID from a communication apparatus by using a radio communication, by calling, based on a wireless signal, the communication apparatus having attached its own apparatus ID and performing the radio communication by receiving a call based on the wireless signal;
(2) a process of storing a read ID which is the apparatus ID read;
(3) a process of storing in advance a prepared ID which is the apparatus ID to be read by the reader unit; and
(4) a process of specifying the unread apparatus ID as an unread ID by comparing the prepared ID stored and the read ID stored.

An ID (identification) reading method performed by a reading apparatus which comprises a reader unit, a first storing unit, a second storing unit, and a specifying unit, which comprises the steps of:

(1) reading, by the reader unit, an apparatus ID from a communication apparatus by using a radio communication, by calling, based on a wireless signal, the communication apparatus having attached its own apparatus ID (identification) and performing the radio communication by receiving a call based on the wireless signal;
(2) storing, by the first storing unit, a read ID which is the apparatus ID read by the reader unit;
(3) storing, by the second storing unit, in advance a prepared ID which is the apparatus ID to be read by the reader unit; and
(4) specifying, by the specifying unit, the unread apparatus ID as an unread ID by comparing the prepared ID stored and the read ID stored.

### EFFECTS OF THE INVENTION

According to the present invention, when reading of an IC tag attached to a commodity fails, the commodity in which the IC tag is attached to can be located easily.

### DESCRIPTION OF THE EXEMPLARY EMBODIMENTS

### First Embodiment

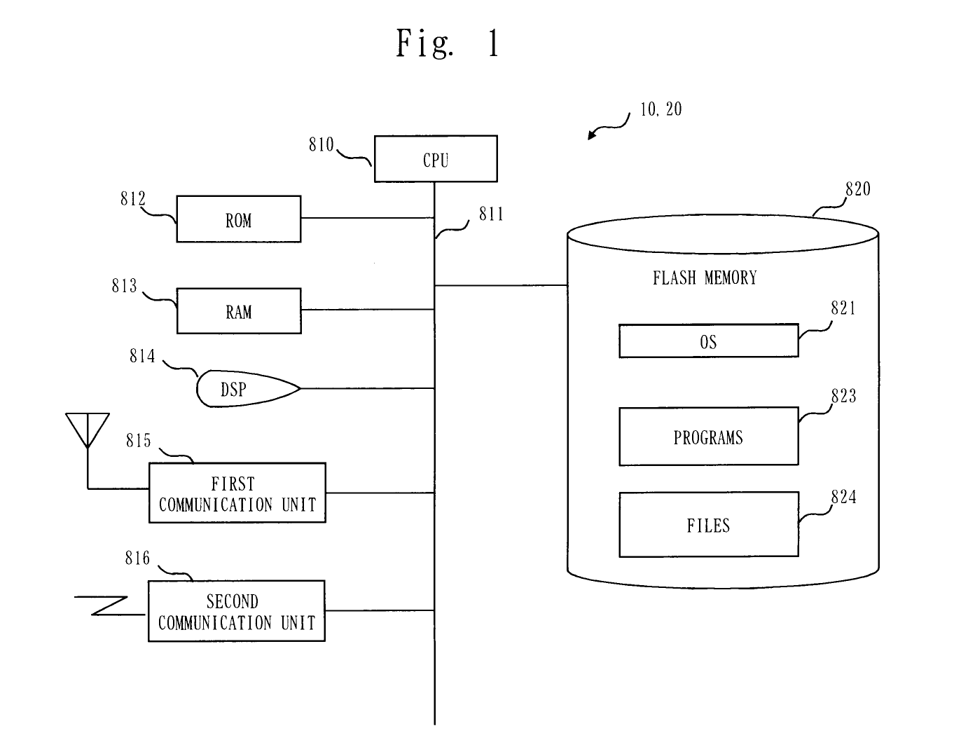

The first embodiment is described with reference to FIGS. 1 to 7. In the first embodiment below, an “invoice data” such as commodity list or delivery statement is stored on a database in advance. The “invoice data” includes, upon receipt of the commodity, a tag ID (herein after may be referred to as a prepared ID) of an IC tag to be read at a time of the receipt. Prior to the receipt of the commodity, the gate type RFID apparatus 10 of the first embodiment acquires in advance the prepared ID from a database storing unit. Then, the gate type RFID apparatus 10, when reading of the IC tag fails, compares a tag information which was able to read (the tag ID which was readable (herein after, it may be referred to as a read ID)) and the “invoice data” (the prepared ID). In this way, the gate type RFID apparatus 10 specifies a tag ID of the unread IC tag (herein after, it may be referred to as an unread ID), based on a difference between the prepared ID and the read ID. Moreover, a corresponding relation between a tag ID and a commodity attaching an IC tag which carries the tag ID is managed by an invoice information stored on the database storing unit. For this reason, it becomes possible to specify an unread ID of a commodity attaching the IC tag that carries the unread ID. Moreover, in the first embodiment, the database storing unit stores the tag ID and a “visual information” which is an information related to an external appearance of the commodity attaching the IC tag that carries the tag ID, by associating them with one another. The gate type RFID apparatus 10, by using the “unread ID” specified, acquires from the database storing unit the “visual information” such as shape, dimension and color of the commodity attaching the unread tag. By using this “visual information”, the commodity attaching the unread IC tag can be located easily even more.

Herein, we may use expression “reading the IC tag”, however, this means that the information stored on the IC tag is read. Moreover, the gate type RFID apparatus 10 is described herein but this is only one example.

FIG. 1 is a hardware configuration chart of the gate type RFID apparatus 10. The hardware configuration chart of the handy type RFID apparatus 20 is the same. Referring to FIG. 1, the gate type RFID apparatus 10 comprises a CPU 810 (may also be referred to as a central processing apparatus, a processing apparatus, an arithmetic apparatus, a microprocessor, a microcomputer, and a processor) for executing programs. The CPU 810 is connected to a ROM (Read Only Memory) 812, a RAM (Random Access Memory) 813, a displaying apparatus 814, a first communication unit 815, a second communication unit 816, and a flash memory 820, via a bus 811, and controls these hardware devices. Instead of the flash memory 820, a magnetic disk apparatus may also be used.

The RAM 813 is one example of a volatile memory. A storage medium such as the ROM 812, the flash memory 820, or the like is one example of a non-volatile memory. These are one example of a storage apparatus or storing/storage unit.

The first communication unit 815 performs a wireless communication with an IC tag (the communication apparatus) which will be described later. The second communication unit 816 communicates to a host PC which will be described later.

The flash memory 820 stores an operating system 821 (OS), programs 823, and files 824. Programs in the programs 823 are executed by the CPU 810 and the operating system 821.

The programs 823 store a program that controls the gate type RFID apparatus 10.

Further, in the explanation of the first embodiment which will be described below, those described as “ . . . unit” or “reader/writer apparatus” may also mean “ . . . circuit”, “ . . . apparatus”, “ . . . device”, and “ . . . means”, or also may be “ . . . step”, “ . . . procedure” and “ . . . process”. That is, what is described as “ . . . unit” may also be implemented on a firmware stored on the ROM 812. Alternatively, it may be implemented only on a software, a hardware such as element, device, substrate, wire and the like, a combination of the software and hardware, or a combination with the firmware. The programs allow a computer to operate as “ . . . unit” or “reader/writer apparatus” described below. Alternatively, the program executes a procedure or method of the “ . . . units” or “reader/writer apparatus” described below by the computer.

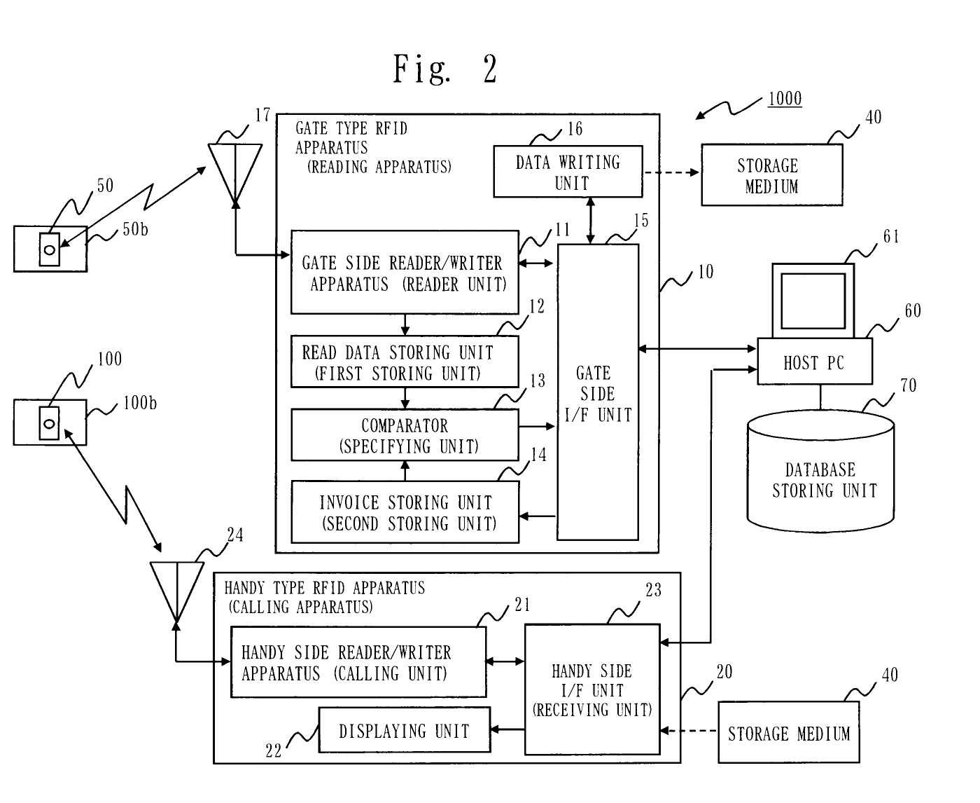

FIG. 2 illustrates a system configuration chart of the IC tag reading system 1000 in accordance with the first embodiment. The IC tag reading system 1000 comprises the gate type RFID apparatus 10 and the handy type RFID apparatus 20.

The gate type RFID apparatus 10 comprises a gate side reader/writer apparatus 11 (the reader unit), a read data storing unit 12 (the first storing unit), a comparator 13 (the specifying unit), an invoice storing unit 14 (the second storing unit), a gate side I/F unit 15, a data writing unit 16, and an antenna 17.

(1) The gate side reader/writer apparatus 11 calls an IC tag (an example of the communication apparatus) attached to a commodity by using a wireless signal, and reads tag information from the IC tag by means of a wireless communication. This tag information includes the tag ID (Identification: an example of the apparatus ID) specially attached to that IC tag.

(2) The read data storing unit 12 stores “IC tag information including the tag ID, a serial number, manufacturer number and model name of the commodity” read by the gate side reader/writer apparatus 11.
(3) The comparator 13 specifies the unread IC tag (the unread ID)
(4) The invoice storing unit 14 stores the “invoice data” such as the commodity list or the delivery statement. As described in the beginning of the first embodiment, the “invoice data” includes the prepared ID.
(5) The gate side I/F unit 15 performs data transmission and reception with the host PC 60.
(6) The data writing unit 16 writes the unread ID specified by the comparator 13 to the storage medium 40 which is capable of writing data. The handy type RFID apparatus 20 can read the unread ID by connecting to the storage medium 40.
(17) The antenna 17 performs transmission and reception of the radio waves.

The handy type RFID apparatus 20 includes a handy side reader/writer apparatus 21 (the calling unit), a displaying unit 22, a handy side I/F unit 23 (the receiving unit), and an antenna 24.

(1) The handy side reader/writer apparatus 21 performs a search of the unread IC tag. That is, the handy side reader/writer apparatus 21, based on the tag ID (the unread ID) received by the handy side I/F unit 23, transmits a call signal for calling the IC tag carrying that ID, at the same time, receives a response signal for responding to the call signal from that IC.
(2) The displaying unit 22 displays the IC tag information including a serial number, a manufacturer number and a model name of the commodity which is unread. Moreover, the displaying unit 22 displays a “reception display” which will be described later when the handy side reader/writer apparatus 21 receives the response signal. Moreover, the displaying unit 22 displays the “visual information”.
(3) The handy side I/F unit 23 performs data transmission and reception with the host PC 60. Moreover, the handy side I/F unit 23 can read from the storage medium 40 the unread ID of the unread IC tag by connecting to the storage medium 40.
(4) The antenna 24 performs transmission and reception of the radio waves for searching the unread IC tag.

The IC tag of the first embodiment can communicate to the gate type RFID apparatus 10 and the handy type RFID apparatus 20. Further, hereinbelow, an IC tag 50 indicates an IC tag for which the tag information was able to be read by the gate type RFID apparatus 10, and a commodity 50b is a commodity attaching the IC tag 50. Moreover, an IC tag 100 indicates an IC tag for which the tag information was unable to be read by the gate type RFID apparatus 10, and a commodity 100b is a commodity attaching the IC tag 100.

The host PC (personal computer) 60 controls the gate type RFID apparatus 10 and the handy type RFID apparatus 20. The host PC 60 provides a PC displaying apparatus 61.

The database storing unit 70 stores the “invoice data” such as the commodity list or the delivery statement.

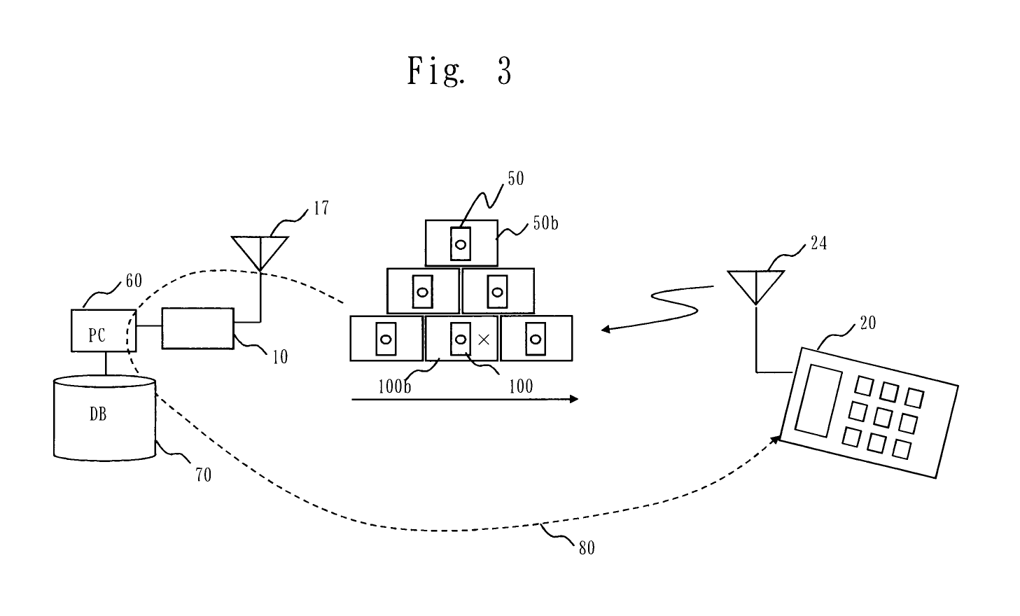

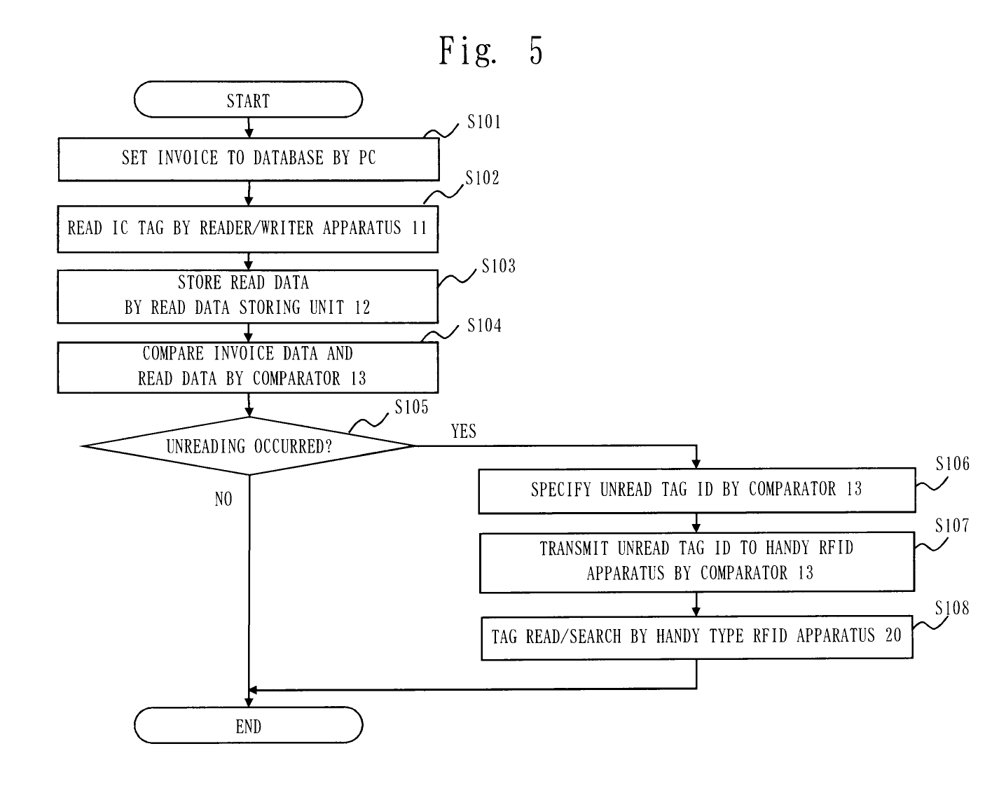

FIG. 3 is a drawing for describing an outline of operation of the IC tag reading system 1000. FIG. 3 shows a piled-up state of a plurality of commodities attaching the IC tags being transported. FIG. 3 illustrates an operation involved until locating “the commodity 100b attaching the IC tag 100” by the handy type RFID apparatus 20, when the IC tags of a plurality of commodities are read all at once by the gate type RFID apparatus 10 but reading of the IC tag 100 has failed. Further, the specific contents of process of FIG. 3 will be described later in the flowchart of FIG. 5. As shown in FIG. 3, the host PC 60 is connected to the database storing unit 70 that stores a database of the “commodity list”. The gate type RFID apparatus 10 is connected to this host PC 60.

An outline of the operation is as follows. The gate type RFID apparatus 10 acquires information of the “commodity list” (the invoice data including the prepared ID) from the database storing unit 70. After acquisition of the “commodity list”, the gate type RFID apparatus 10 reads the IC tags (the tag IDs) attached to the piled-up commodities all at once. Then, the gate type RFID apparatus 10 collates the read ID and the acquired “commodity list” (the prepared ID), and specifies the unread ID. Then, the gate type RFID apparatus 10 transmits information of the unread IC tag 100 (the unread ID) to the handy type RFID apparatus 20, by a wireless LAN (local area network) 80 and the like.

(Handy Type RFID Apparatus 20)

The handy type RFID apparatus 20, based on the information transmitted from the gate type RFID apparatus 10 (the unread ID), searches for the unread IC tag 100 among the piled-up commodities. Based on the above processes, the commodity 100b attaching the unread IC tag 100 is easily located.

(Use of the Visual Information)

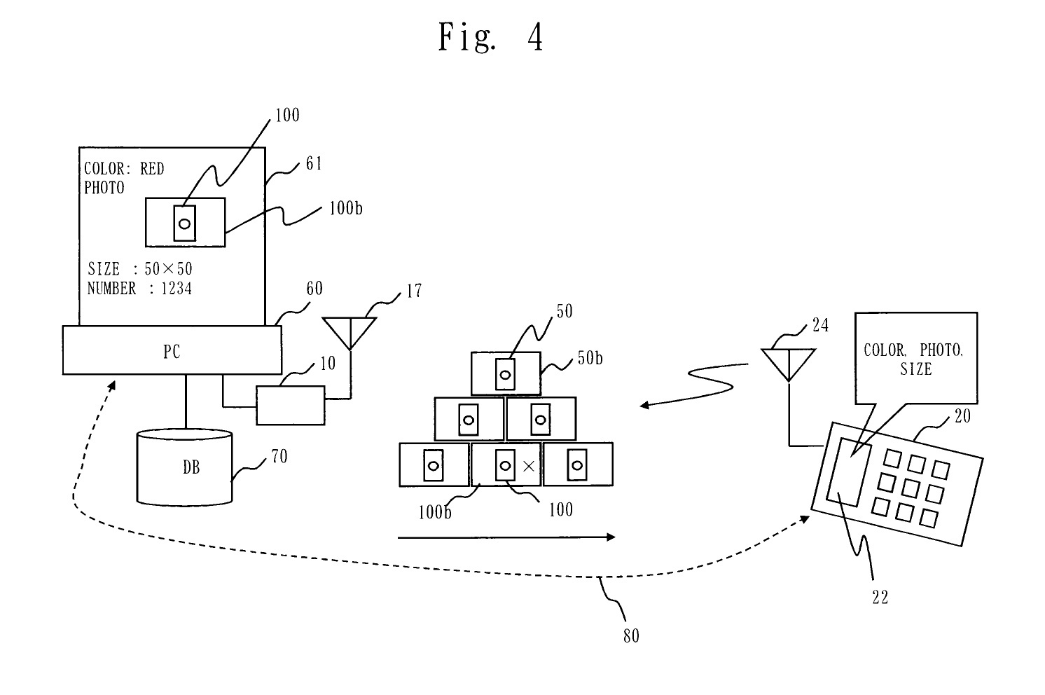

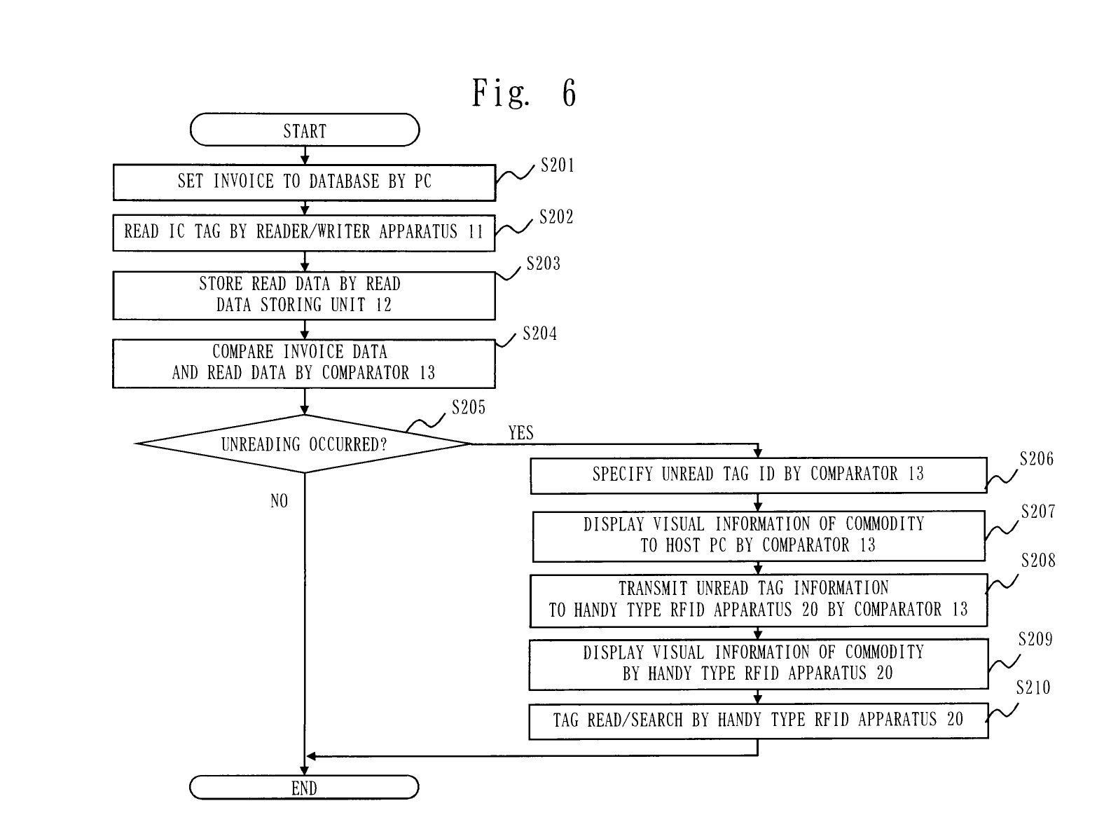

FIG. 4 illustrates an outline of the operation of the IC tag readout system 1000 in case of using the “visual information”. By using the “visual information”, a worker can visually search for the commodity 100b attaching the unread IC tag 100. Based on this, the commodity attaching the unread IC tag can efficiently be located. As described above, the “visual information” is an information related to the external appearance of the commodity attaching the IC tag, being the information such as shape, dimension and color of the commodity. As FIG. 4 shows, the “visual information” is displayed on the displaying unit 22 of the handy type RFID apparatus 20 in the end. The “visual information” can be image information or words information. Moreover, a specific process of FIG. 4 will be described later in an explanation of the flowchart of FIG. 6.

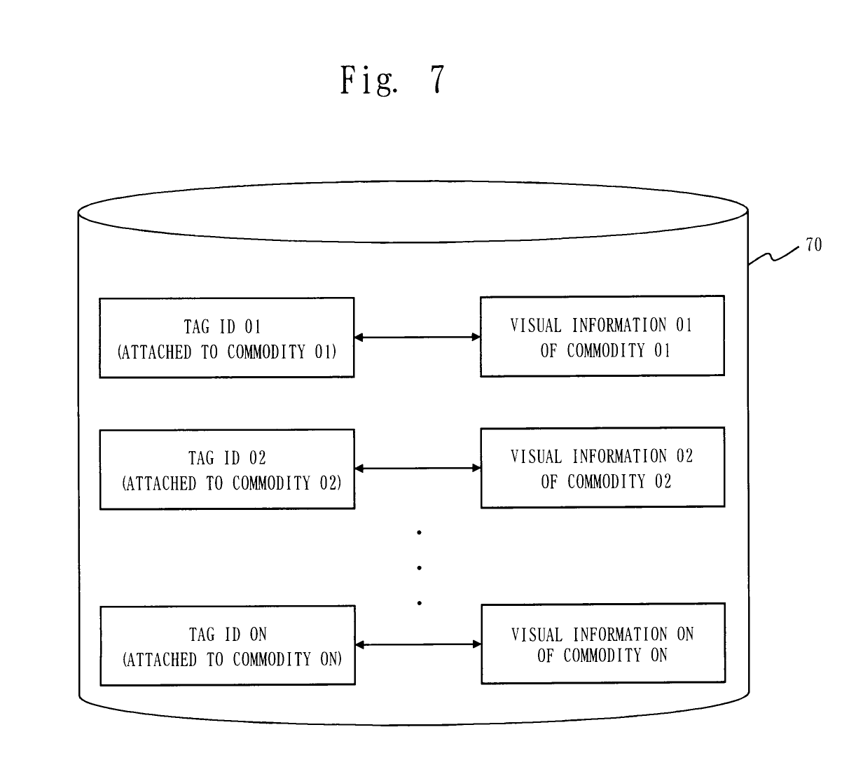

The system configuration of FIG. 4 is the same as the case of FIG. 3. Meanwhile, the database storing unit 70 provides information that corresponds a tag ID with the “visual information” of the commodity attaching the IC tag that carries this tag ID. This will be described later in FIG. 7.

An outline of the operation follows next. The processes involved up to specifying of the unread IC tag 100 is the same as that in FIG. 3. When the gate type RFID apparatus 10 specifies the unread IC tag 100, it searches the database storing unit 70 by using the “tag ID” (unread ID) of the unread IC tag 100 as a key, and specifies the “visual information” corresponding to that “tag ID”. That is, the gate type RFID apparatus 10 specifies the “visual information” of the commodity 100b attaching the IC tag 100 in the database storing unit 70. Then, the gate type RFID apparatus 10 displays the “visual information” of the commodity 100b on the PC displaying apparatus 61 of the host PC 60. Moreover, at the same time, the gate type RFID apparatus 10 transmits the “tag ID” of the IC tag 100 and the “visual information” of the commodity 100b to the handy type RFID apparatus 20, via the wireless LAN 80.

(Handy Type RFID Apparatus 20)

A worker uses a reader/writer function of the handy type RFID apparatus 20, and searches for the commodity 100b attaching the IC tag 100 unread among the piled-up commodities, based on the “tag ID” received from the gate type RFID apparatus 10. At the same time, the handy type RFID apparatus 20 displays on the displaying unit 22 the “visual information” of the commodity 100b transmitted from the gate type RFID apparatus 10. Based on this, the worker can visually search the commodity 100b.

FIG. 5 is a flowchart showing the specific content of processing of FIG. 3. A detail of the process outline explained in FIG. 3 will be described with reference to FIG. 5.

In step 101, the host PC 60 stores in advance the information on the commodity list or the information on the delivery statement (these include the prepared ID) upon shipment or receipt, to the database storing unit 70 which is connected to the host PC 60, as the “invoice data”. The invoice storing unit 14 of the gate type RFID apparatus 10 receives from the database storing unit 70, before the receipt if receiving the commodity or before the shipment if dispatching the commodity, acquires and stores the invoice data of the commodity in subject of the shipment or receipt. The invoice data includes the prepared ID which is intended to be read by the gate type RFID apparatus 10.

In step 102, the gate side reader/writer apparatus 11 of the gate type RFID apparatus 10 reads the IC tag (includes the tag ID) attached to the commodity all at once.

In step 103, the read data storing unit 12 stores the read ID read by the gate side reader/writer apparatus 11.

In step 104, the comparator 13 compares the read ID stored by the read data storing unit 12 and the prepared ID stored by the invoice storing unit 14. The comparator 13 determines a difference between the read ID and the prepared ID. For example, when the prepared IDs are “0099”, “0100” and “0101” and the read IDs are “0099” and “0101”, the comparator 13 determines their differences.

In step 105, the comparator 13, as a result of the comparison, when the compared results are the same (that is, the case of no difference), determines that the IC tag has not failed to be read, and ends the process. The comparator 13 proceeds to step 106, when compared results are different.

(S106)

In step 106, the comparator 13 specifies “unread ID” which is unread by the gate side reader/writer apparatus 11, based on the read ID stored on the read data storing unit 12 and the prepared ID stored on the invoice data storing unit. In the example of S104, the comparator 13 specifies “0100” as the unread ID, based on the differences.

In step 107, the comparator 13 transmits “0100” which is the “unread ID” specified in step 106, to the handy type RFID apparatus 20 via the host PC 60.

(Handy Type RFID Apparatus 20)

In step 108, the handy type RFID apparatus 20 receives “0100” of the “unread ID” transmitted in step 107 at the handy side I/F unit 23. The handy side reader/writer apparatus 21 performs a call of the IC tag 100 based on “0100” of the “unread ID”, and searches it. For example, a worker brings the handy type RFID apparatus 20 close to the commodities, and searches the IC tag 100 unread by the gate side reader/writer apparatus 11. That is, the handy side reader/writer apparatus 21, based on “0100” of the unread ID received by the handy side I/F unit 23, transmits a call signal for calling the IC tag 100 carrying this unread ID. The handy side reader/writer apparatus 21 receives the response signal when the IC tag 100 transmits the response signal for responding to this call signal. Then, the displaying unit 22 displays the “reception display” indicating that the response signal is received, when the handy side reader/writer apparatus 21 has received the response signal from the IC tag 100. In this way, the worker can easily locate the commodity 100b attaching the IC tag 100. That is, the worker can confirm whereabouts of the commodity 100b.

Subsequently, with reference to FIG. 6, a detailed process flow of FIG. 4 that uses the “visual information” will be described. Steps 201 to 205 of FIG. 6 is the same as those of FIG. 5. For this reason, explanation of steps 201 to 205 is omitted, and explanation starts from step 206.

In step 206, the comparator 13 specifies a “tag ID” (“0100”) of the IC tag 100 unread by the gate side reader/writer apparatus 11. This step is the same as step 106.

In step 207, the comparator 13, based on “0100” of the unread ID specified in step 206, specifies the “visual information” which is the information related to the external appearance such as shape, dimension and color of the commodity 100b that corresponds to “0100” of the unread ID in the database storing unit 70, at the same time, displays the “visual information” of the commodity 100b to the PC displaying apparatus 61 of the host PC 60. As shown in FIG. 7, in the database storing unit 70, the tag ID and the “visual information” are stored by associating with one another.

In step 208, the comparator 13 transmits the unread ID specified in step 206 and the “visual information” specified in step 207, to the handy type RFID apparatus 20, via the host PC 60. In this example, the comparator 13 transmits the unread ID “0100” and the “visual information” of the commodity 100b, to the handy type RFID apparatus 20, via the host PC 60.

(Handy Type RFID Apparatus 20)

In step 209, the handy type RFID apparatus 20 receives the “visual information” of the commodity 100b and the unread ID “0100”, via the handy side I/F unit 23. Then, the displaying unit 22 stores the “visual information” of the commodity 100b received by the handy side I/F unit 23, and displays it as required.

Step 210 is the same as step 108. The handy side reader/writer apparatus 21 performs a call of the IC tag carrying the unread ID, and searches for the IC tag 100. That is, a worker brings the handy side RFID apparatus 20 close to the commodities, and searches for the commodity 100b attaching the unread IC tag 100. As shown in FIG. 4, the displaying unit 22 displays the “visual information” of the commodity 100b. Therefore, the worker can easily locate easily the commodity 100b by referring to this display.

As stated above, in checking the commodity all at once by using the commodity checking system represented by the gate type RFID apparatus, when reading of the IC tag fails, conventionally, the unread IC tag was searched by the worker, so that there was a problem of taking too much time until locating it.

However, the invoice data such as the commodity list or the delivery statement is prepared in advance, a comparing function for comparing the read data and the invoice data is added to the RFID apparatus, and the commodity 100b attaching to the unread IC tag 100 is searched by using the handy type RFID apparatus 20. In this way, a searching time is remarkably reduced compared to the conventional searching time spent by the worker.

Moreover, the comparing function for comparing the read data and the invoice data, which is added to the conventional RFID apparatus, may be installed on the host PC 60 or the handy type RFID apparatus, instead of installing it inside of the RFID apparatus, to get the same result still.

In the first embodiment described above, the following gate type RFID apparatus 10 has been described. That is, in the gate type RFID apparatus for performing the wireless communication with the IC tag, the gate type RFID apparatus comprises: the reader/writer apparatus that reads the tag information including the serial number, manufacturer number and the model name of the commodity; a read data storing unit that stores the “tag information” read by the reader/writer apparatus; a gate side I/F unit that receives data from the host PC that controls the database storing the invoice data such as the commodity list or the delivery statement; an invoice storing unit that stores the invoice data received by the gate side I/F unit; and a comparator that compares the data of the read data storing unit and the data of the invoice storing unit and that specifies the unread tag. The gate side I/F unit transmits the compared results of the comparator to the host PC.

In the first embodiment described above, the following handy type RFID apparatus 20 has been described. That is, the handy type RFID apparatus comprises: the handy side I/F unit that receives the tag information and the visual information from the gate type RFID apparatus via the host PC; the displaying unit that displays the tag information and the visual information received by the handy side I/F unit; and the handy side reader/writer apparatus that searches the unread IC tag based on the tag information received by the handy side I/F unit.

### BRIEF DESCRIPTION OF THE DRAWINGS

[FIG. 1] A hardware configuration chart of the gate type RFID apparatus 10 and the handy type RFID apparatus 20.

[FIG. 2] A system configuration chart of the IC tag reading system 1000.

[FIG. 3] A drawing for describing the outline of operation of the IC tag reading system 1000.

[FIG. 4] A drawing showing the outline of operation of the IC tag reading system 1000 in case of using the “visual information”

[FIG. 5] A flowchart showing the specific content of processing of FIG. 3.

[FIG. 6] A flowchart showing a specific content of processing of FIG. 4.

[FIG. 7] A drawing showing a relationship of the tag ID and the visual information possessed by the database storing unit.

### Explanation of Signs

gate type RFID apparatus (10), gate side reader/writer apparatus (11), read data storing unit (12), comparator (13), invoice storing unit (14), gate side I/F unit (15), data writing unit (16), antenna (17), handy type RFID apparatus (20), handy side reader/writer apparatus (21), displaying unit (22), handy side I/F unit (23), antenna (24), storage medium (40), IC tag (50), commodity (50b), host PC (60), PC displaying apparatus (61), database storing unit (70), wireless LAN (80), IC tag (100), commodity (100b), CPU (810), bus (811), ROM (812), RAM (813), displaying apparatus (814), first communication unit (815), second communication unit (816), flash memory (820), OS (821), programs (823), files (824), IC tag reading system (1000)

1. A reading apparatus, comprising:
a reader unit that reads an apparatus ID from a communication apparatus by using a radio communication, by calling, based on a wireless signal, the communication apparatus having attached its own apparatus ID (identification) and performing the radio communication by receiving a call of the wireless signal, wherein the communication apparatus is attached to a commodity;
a first storing unit that stores a read ID which is the apparatus ID read by the reader unit;
a second storing unit that stores in advance a prepared ID which is the apparatus ID to be read by the reader unit; and
a specifying unit that specifies an apparatus ID failed to be read by the reader unit as an unread ID, by comparing the read ID stored by the first storing unit and the prepared ID stored by the second storing unit.

2. The reading apparatus according to claim 1, wherein the specifying unit transmits the specified unread ID to an other apparatus.

3. The reading apparatus according to claim 2, wherein the specifying unit transmits the unread ID to a calling apparatus, as the other apparatus, that can perform the radio communication, by calling the communication apparatus based on the apparatus ID.

4. The reading apparatus according to claim 1, wherein the specifying unit specifies the visual information corresponding to the unread ID by communicating to a database storing unit that stores, by associating the visual information which is an information related to an external appearance of the commodity attaching the communication apparatus with the apparatus ID of the communication apparatus.

5. The reading apparatus according to claim 4, wherein the specifying unit transmits the unread ID specified and the visual information corresponding to the unread ID, to an other apparatus.

6. The reading apparatus according to claim 1, wherein the second storing unit acquires the prepared ID from a database storing unit that stores the prepared ID, and stores the prepared ID acquired.

7. The reading apparatus according to claim 1 further comprises a data writing unit for writing the unread ID specified by the specifying unit to a storage medium which is capable of writing data.

8. A calling apparatus, comprising:
a receiving unit that receives an unread ID from a specifying unit of a reading apparatus which includes: a reader unit that reads an apparatus ID from a communication apparatus by using a radio communication, by calling, based on a wireless signal, the communication apparatus having attached its own apparatus ID (identification) and performing the radio communication by receiving a call of the wireless signal, wherein the communication apparatus is attached to a commodity; a first storing unit that stores a read ID which is the apparatus ID read by the reader unit; a second storing unit that stores in advance a prepared ID which is the apparatus ID to be read by the reader unit; and a specifying unit that specifies an apparatus ID failed to be read by the reader unit as an unread ID, by comparing the read ID stored by the first storing unit and the prepared ID stored by the second storing unit, and that transmits the specified unread ID to an other apparatus;
a calling unit that transmits a call signal for calling the communication apparatus having the unread ID based on the unread ID received by the receiving unit, and that receives from the communication apparatus being called a response signal for responding to the call signal; and
a displaying unit that displays a reception display indicating reception of the response signal by the calling unit when the call response signal is received by the calling unit.

9. A calling apparatus, comprising:
a receiving unit that receives an unread ID from a specifying unit of a reading apparatus which includes: a reader unit that reads an apparatus ID from a communication apparatus by using a radio communication, by calling, based on a wireless signal, the communication apparatus having attached its own apparatus ID (identification) and performing the radio communication by receiving a call of the wireless signal, wherein the communication apparatus is attached to a commodity; a first storing unit that stores a read ID which is the apparatus ID read by the reader unit; a second storing unit that stores in advance a prepared ID which is the apparatus ID to be read by the reader unit; and a specifying unit that specifies an apparatus ID failed to be read by the reader unit as an unread ID, by comparing the read ID stored by the first storing unit and the prepared ID stored by the second storing unit, that specifies visual information corresponding to the unread ID by communicating to a database storing unit that stores, by associating the visual information which is an information related to an external appearance of the commodity attaching the communication apparatus with the apparatus ID of the communication apparatus, and that transmits the specified unread ID and the visual information to an other apparatus;
a calling unit that transmits a call signal for calling the communication apparatus having the unread ID based on the unread ID received by the receiving unit, and that receives from the communication apparatus being called a response signal for responding to the call signal; and
a displaying unit that displays a visual information corresponding to the unread ID which is used for calling by the calling unit when the call response signal is received by the calling unit.

10. An ID (Identification) reading program which is characterized in that the following processes executed by a computer is serving as the reading apparatus,
(1) a process of reading an apparatus ID from a communication apparatus by using a radio communication, by calling, based on a wireless signal, the communication apparatus having attached its own apparatus ID and performing the radio communication by receiving a call of the wireless signal, wherein the communication apparatus is attached to a commodity;
(2) a process of storing a read ID which is the apparatus ID read;
(3) a process of storing in advance a prepared ID which is the apparatus ID to be read by the reader unit; and
(4) a process of specifying the unread apparatus ID as an unread ID by comparing the prepared ID stored and the read ID stored.

11. An ID (identification) reading method performed by a reading apparatus which comprises a reader unit, a first storing unit, a second storing unit, and a specifying unit, which comprises the steps of:
(1) reading, by the reader unit, an apparatus ID from a communication apparatus by using a radio communication, by calling, based on a wireless signal, the communication apparatus having attached its own apparatus ID (identification) and performing the radio communication by receiving a call of the wireless signal, wherein the communication apparatus is attached to a commodity;
(2) storing, by the first storing unit, a read ID which is the apparatus ID read by the reader unit;
(3) storing, by the second storing unit, in advance a prepared ID which is the apparatus ID to be read by the reader unit; and
(4) specifying, by the specifying unit, the unread apparatus ID as an unread ID by comparing the prepared ID stored and the read ID stored.
